(19) United States
(12) Patent Application Publication
(10) Pub. No.: US 2009/0207610 A1
(43) Pub. Date: Aug. 20, 2009

(54) COMBINATION REAR LIGHTING SYSTEM

(76) Inventors: Edwin Mitchell Sayers, Saline, MI (US); Chris L. Eichelberger, Livonia, MI (US)

Correspondence Address: FRASER CLEMENS MARTIN & MILLER LLC, 28366 KENSINGTON LANE, PERRYSBURG, OH, 43551, US

(21) Appl. No.: 12/033,622

(22) Filed: Feb. 19, 2008

(51) Int. Cl. F21V 7/00

(52) U.S. Cl. 362/247

(57) ABSTRACT

A lighting system that includes a common optical system to achieve both rear fog and rear position or tail functions is disclosed, the lighting system including a light guide having a first side and a second side, the first side of the light guide having a plurality of optical devices formed therein; a first light source disposed adjacent one of the optical devices, wherein the optical device reflects and substantially collimates light rays emitted from the first light source through the light guide and into a first desired lighting pattern; and a second light source disposed adjacent one of the optical devices, wherein the optical device reflects and substantially collimates light rays emitted from the second light source through the light guide and into a second desired lighting pattern.

### FIELD OF THE INVENTION

The present invention relates to lighting systems and more particularly, a combination rear fog and tail lighting system for a vehicle.

### BACKGROUND OF THE INVENTION

Manufacturers of vehicle lighting systems are constantly striving to consolidate components of various systems. This includes combining lighting functions such that the same optical system can be used to provide different functions by switching different sources on and off. Some typical examples of combined functions are stop/tail lights in rear lamps and low/high beams in headlamps. Although this is advantageous, some functions are not combined because of extreme differences in requirements (e.g. different color, and large differences in intensity requirements).

One such function is the European rear fog lighting. The acceptable intensity range for European rear fog lighting is narrow and requires a substantial amount of light flux. Further, the shape of the light distribution pattern is tightly controlled. While the rear fog is often incorporated into the rear lamp assembly, it still requires a separate optical system. The additional optical system required for the incorporation of rear fog and tail lighting systems adds cost and uses valuable lamp volume.

It would be desirable to have a lighting system that includes a common optical system to achieve both rear fog and rear position or tail functions.

### SUMMARY OF THE INVENTION

Concordant and consistent with the present invention, a lighting system that includes a common optical system to achieve both rear fog and rear position or tail functions, is surprisingly discovered.

In one embodiment, a lighting system comprises a light guide having a plurality of optical devices formed therein; a first light source disposed adjacent one of the optical devices, wherein the optical device substantially collimates light rays emitted from the first light source through the light guide and into a first desired lighting pattern; and a second light source disposed adjacent one of the optical devices, wherein the optical device reflects and substantially collimates light rays emitted from the second light source through the light guide and into a second desired lighting pattern.

In another embodiment, a lighting system comprises a light guide having a plurality of optical devices formed therein; a first light source disposed adjacent the light guide; a light directing device for directing the light emitted from the first light source into a plurality of first light inputs, wherein the first light inputs direct the light emitted from the light directing device toward at least one of the optical devices, the optical device substantially collimating the emitted light through the light guide and into a first lighting pattern; and a second light source disposed adjacent one of the optical devices, wherein the optical device reflects and substantially collimates light rays emitted from the second light source through the light guide and into a second lighting pattern.

In another embodiment, a lighting system comprises a light guide having a plurality of optical devices formed therein; a first light source disposed adjacent the light guide; a light directing device for directing the light emitted from the first light source into a plurality of first light inputs, wherein the first light inputs direct the light emitted from the light directing device toward at least one of the optical devices, the optical device substantially collimating the emitted light through the light guide and into a first lighting pattern; a second light source disposed adjacent the light guide; and a light directing device for directing the light emitted from the second light source into a plurality of second light inputs, wherein the second light inputs direct the light emitted from the light directing device toward at least one of the optical devices, the optical device substantially collimating the emitted light through the light guide and into a second lighting pattern.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a top cross-sectional view of a lighting system according to an embodiment of the present invention;

FIG. 2 is a perspective view of the lighting system of FIG. 1;

FIG. 3 is a top cross-sectional view of a lighting system according to another embodiment of the present invention; and

FIG. 4 is a top cross-sectional view of a lighting system according to another embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

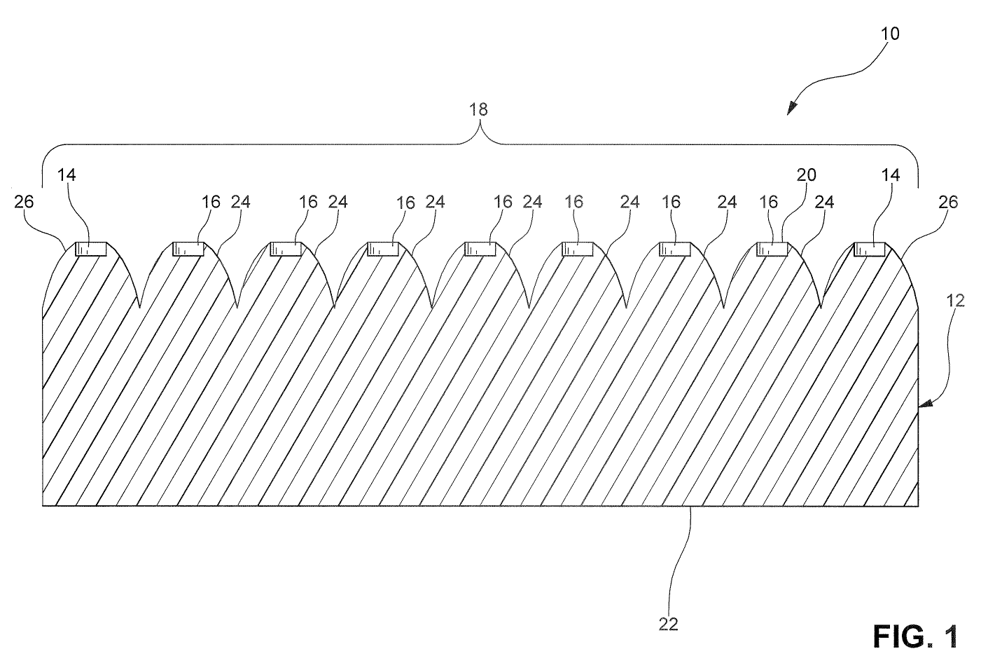

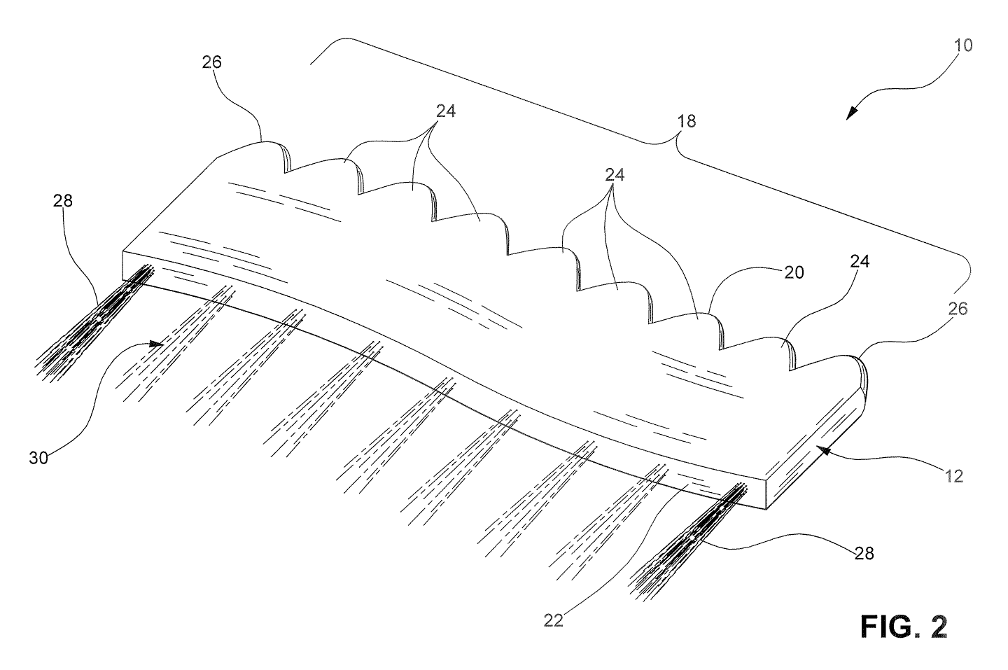

FIGS. 1 and 2 show a lighting system 10 according to an embodiment of the present invention. The lighting system 10 includes a light guide 12, a first light source 14, and a second light source 16.

The light guide 12, also referred to as an optical system, is formed from optical-grade material. It is understood that the light guide 12 may be formed from any optical-grade material such as an optical-grade plastic, acrylic, and polycarbonate, for example. The light guide 12 includes a first side 20 and a second side 22. The second side 22 of the light guide 12 is adapted to emit light rays from within the light guide 12. A skilled artisan may select any suitable shape, size, and optical characteristics for the light guide 12.

The light guide 12 further includes a plurality of optical devices 18 for directing light in a desired lighting pattern. The plurality of optical devices 18 may be formed in the light guide 12. It is understood that the optical devices 18 may each be any conventional optical device for directing light, as desired. It is further understood that the light guide 12 may include any number of optical devices 18, as desired. The optical devices 18 are shown as protuberances having an arcuate shape for directing and substantially collimating light in a desired direction and lighting pattern. It is understood that the optical devices 18 may have any shape as desired. Other optical devices 18 may also be employed as desired.

As shown, the optical devices 18 may include a plurality of inner optical devices 24 and outer optical devices 26 formed in the light guide 12, wherein each optical device 24, 26 directs light in a desired lighting pattern. The outer optical devices 26 may be disposed adjacent an edge of the light guide 12. The inner optical devices 24 may be disposed between the outer optical devices 26. It is understood that any number and any configuration of inner optical devices 24 and outer optical devices 26 may be included, as desired. Each of the inner optical devices 24 and the outer optical devices 26 may be adapted to receive at least one of the first light source 14 and the second light source 16. It is understood that each of the inner optical devices 24 and the outer optical devices 26 may be adapted to receive additional optical elements such as reflectors and collimating optics, for example. It is further understood that the first side 20 and second side 22 of the light guide 12 may also be adapted to receive additional optical elements (not shown) for creating a desired lighting effect.

The first light source 14 is disposed adjacent at least one of the optical devices 18. As a non-limiting example, the first light source 14 is disposed adjacent the outer optical devices 26 of the light guide 12. It is understood that the first light source 14 may be disposed adjacent any of the optical devices 18, as desired. Although the first light source 14 is shown as a plurality of high intensity LEDs, it is understood that the first light source 14 may be any conventional light source. Other suitable light sources may also be employed.

The second light source 16 is disposed adjacent at least one of the optical devices 18. As a non-limiting example, the second light source 16 is disposed adjacent the inner optical devices 24 of the light guide. It is understood that the second light source 16 may be disposed adjacent any of the optical devices 18, as desired. Although the second light source 16 is shown as a plurality of low intensity LEDs, it is understood that the second light source 16 may be any conventional light source, as desired. Other suitable light sources may also be employed.

In operation, the first light source 14 may emit high intensity light rays 28. The high intensity light rays 28 are substantially reflected and collimated by at least one of the optical devices 18. The optical devices 18 direct the high intensity light rays 28 through the light guide 12. The high intensity light rays 28 are emitted through the second side 22 of the light guide 12 to produce a desired lighting effect, as shown in FIG. 2.

The second light source 16 may emit low intensity light rays 30. The low intensity light rays 30 are reflected and substantially collimated by at least one of the optical devices 18. The optical devices 18 direct the low intensity light rays 30 through the light guide 12. The low intensity light rays 30 are emitted through the second side 22 of the light guide 12 to produce a desired lighting effect, as illustrated in FIG. 2.

As shown, the high intensity light rays 28 emitted by the first light source 14 are directed into a substantially uniform, narrow, high intensity lighting pattern, thereby providing a rear fog light function. The low intensity light rays 30 emitted by the second light source 16 are directed into a substantially uniform, wide, low intensity lighting pattern, thereby providing a position or tail lighting function. It is understood that the light sources 14, 16, the optical devices 18, and the light guide 12 may be adapted to produce various lighting patterns, as desired.

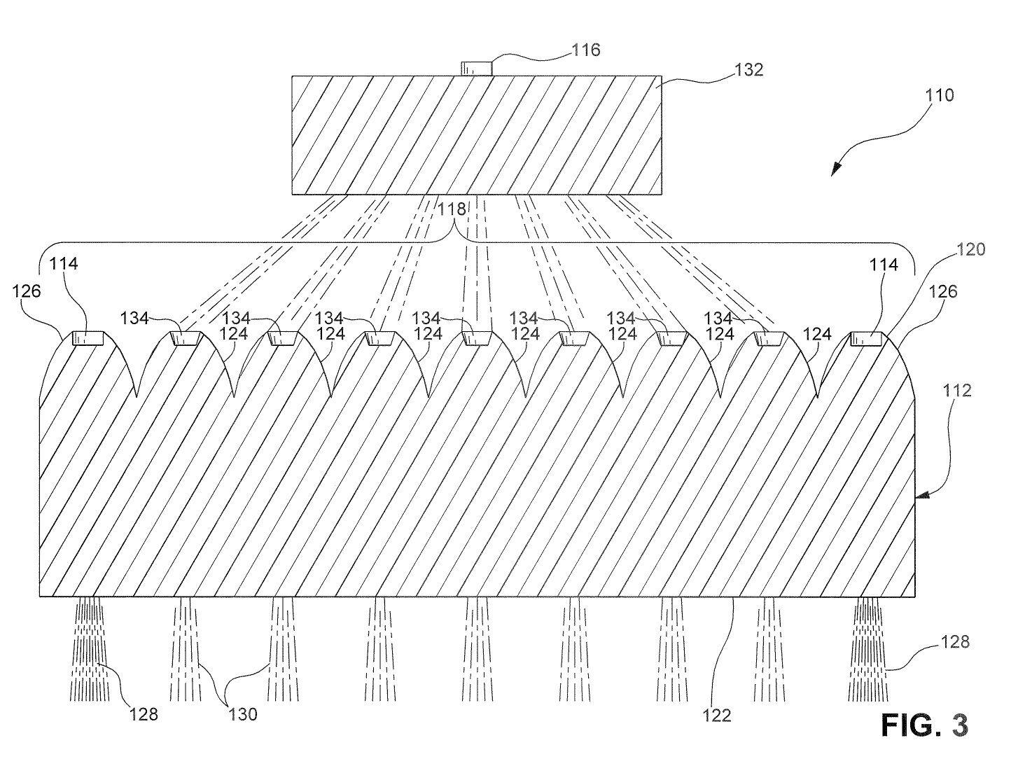

FIG. 3 shows a lighting system 110 according to another embodiment of the present invention. The lighting system 110 includes a light guide 112, a first light source 114, a second light source 116, a light directing device 132, and a plurality of light inputs 134.

The light guide 112, also referred to as an optical system, is formed from optical-grade material in certain embodiments. It is understood that the light guide 112 may be formed from any optical-grade material such as an optical-grade plastic, acrylic, and polycarbonate, for example. The light guide 112 includes a first side 120 and a second side 122. The second side 122 of the light guide 112 is adapted to emit light rays from within the light guide 112. A skilled artisan may select any suitable shape, size, and optical characteristics for the light guide 12.

The light guide 112 further includes a plurality of optical devices 118 for directing light in a desired lighting pattern. The plurality of optical devices 118 may be formed in the light guide 112. It is understood that the optical devices 118 may each be any conventional optical device for directing light, as desired. It is further understood that the light guide 112 may include any number of optical devices 118, as desired. The optical devices 118 are shown as protuberances having an arcuate shape for directing and substantially collimating light in a desired direction and lighting pattern. However, it is understood that the optical devices 118 may have any shape as desired. Other optical devices 118 may also be employed as desired.

The optical devices 118 may include a plurality of inner optical devices 124 and outer optical devices 126 formed in the light guide 112, wherein each optical device 124, 126 directs light in a desired lighting pattern. The outer optical devices 126 may be disposed adjacent an edge of the light guide 112. The inner optical devices 124 may be disposed between the outer optical devices 126. It is understood that any number and any configuration of inner optical devices 124 and outer optical devices 126 may be included, as desired. Each of the inner optical devices 124 and the outer optical devices 126 may be adapted to receive at least one of the first light source 114 and the second light source 116. It is understood that each of the inner optical devices 124 and the outer optical devices 126 may be adapted to receive additional optical elements such as reflectors and collimating optics, for example. It is further understood that the first side 120 and second side 122 of the light guide 12 may also be adapted to receive additional optical elements (not shown) for creating a desired lighting effect.

The first light source 114 is disposed adjacent at least one of the optical devices 118. As a non-limiting example, the first light source 114 is disposed adjacent the outer optical devices 126 of the light guide 112. It is understood that the first light source 114 may be disposed adjacent any of the optical devices 118, as desired. Although the first light source 114 is shown as a plurality of high intensity LEDs, it is understood that the first light source 114 may be any conventional light source, as desired. Other suitable light sources may also be employed.

The second light source 116 is disposed adjacent the light directing device 132. Although the second light source 116 is shown as a low intensity LED, it is understood that the second light source 116 may be any conventional light source, as desired. Other suitable light sources may also be employed.

The light directing device 132 is disposed between the light guide 112 and the second light source 116. The light directing device 132 is adapted to direct a substantial portion of the light emitted from the second light source 116 into at least one of the light inputs 134. It is understood that the light directing device 132 may include any conventional device for directing light in a desired direction and lighting pattern such as a light pipe, a reflector, a mirror, a lens, and a prism, for example.

The light inputs 134 are disposed adjacent at least one of the optical devices 118 of the light guide 112. The light inputs 134 are adapted to receive light emitted from the light directing device 132 and direct the light into the light guide 112. Although the light inputs 134 are shown disposed adjacent the inner optical devices 124 of the light guide 112, it is understood that the light inputs 134 may be disposed in any of the optical devices as desired. It is further understood that the light inputs 134 may include reflectors and other optical elements for receiving and directing light.

In operation, the first light source 114 may emit high intensity light rays 128. The high intensity light rays 128 are reflected and substantially collimated by at least one of the optical devices 118. The optical devices 118 direct the high intensity light rays 128 through the light guide 112. The high intensity light rays 128 are emitted through the second side 122 of the light guide 112 to produce a desired lighting effect.

The second light source 116 may emit low intensity light rays into the light directing device 132. The light directing device 132 directs a substantial portion of the low intensity light rays 130 toward the light inputs 134 of the light guide 112. The light inputs 134, disposed adjacent the optical devices 118, receive a substantial portion of the low intensity light rays 130 emitted from the light directing device 132 and further direct the low intensity light rays 130 into the light guide 112. The low intensity light rays 130 are reflected and substantially collimated by at least one of the optical devices 118. The optical devices 118 direct the low intensity light rays 130 through the light guide 112. The low intensity light rays 130 are emitted through the second side 122 of the light guide 112 to produce a desired lighting effect. As shown, the high intensity light rays 128 emitted by the first light source 114 are directed into a substantially uniform, narrow, high intensity lighting pattern, thereby providing a rear fog light function. The low intensity light rays 130 emitted by the second light source 116 are directed into a substantially uniform, wide, low intensity lighting pattern, thereby providing a position or tail lighting function. It is understood that the light sources 114, 116, the light pipe 112, the optical devices 118, and the light directing device 132 may be adapted to produce various lighting patterns, as desired.

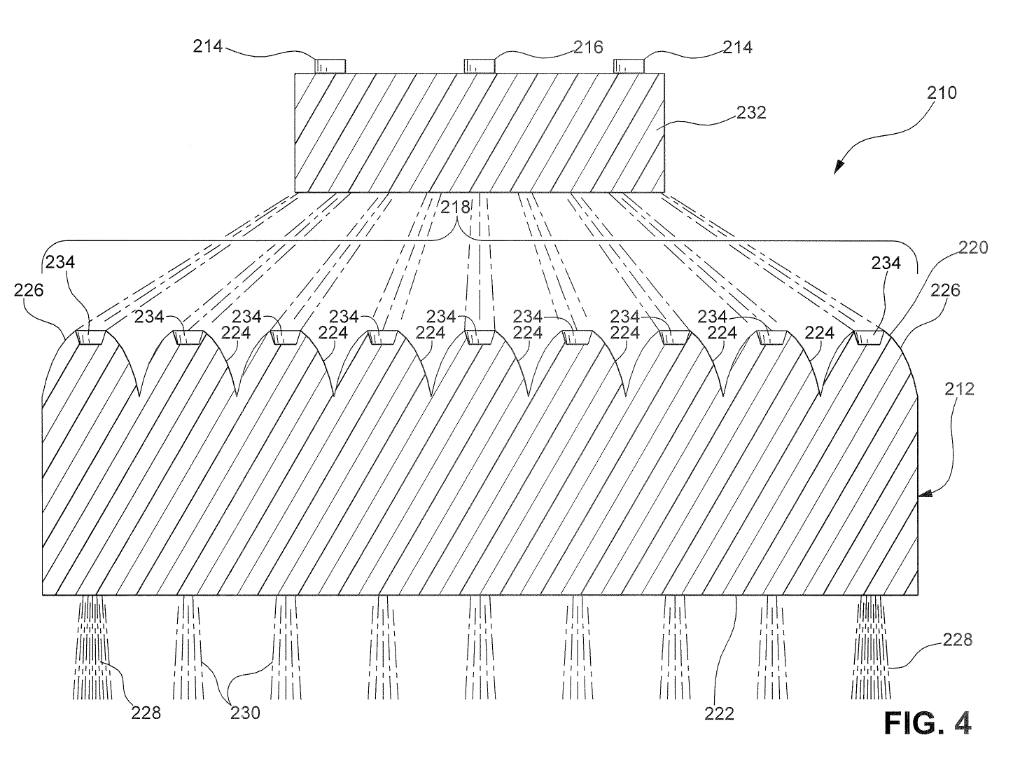

FIG. 4 shows a lighting system 210 according to another embodiment of the present invention. The lighting system 210 includes a light guide 212, a first light source 214, a second light source 216, a light directing device 232, and a plurality of light inputs 234.

The light guide 212, also referred to as an optical system, is formed from optical-grade material in certain embodiments. It is understood that the light guide 212 may be formed from any optical-grade material such as an optical-grade plastic, acrylic, and polycarbonate, for example. The light guide 212 includes a first side 220 and a second side 222. The second side 222 of the light guide 212 is adapted to emit light rays from within the light guide 212. A skilled artisan may select any suitable shape, size, and optical characteristics for the light guide 12.

The light guide 212 further includes a plurality of optical devices 218 for directing light in a desired lighting pattern. The plurality of optical devices 218 may be formed in the light guide 212. It is understood that the optical devices 218 may each be any conventional optical device for directing light, as desired. It is further understood that the light guide 212 may include any number of optical devices 218, as desired. The optical devices 218 are shown as protuberances having an arcuate shape for directing and substantially collimating light in a desired direction and lighting pattern. However, it is understood that the optical devices 218 may have any shape as desired. Other optical devices 218 may also be employed as desired.

The optical devices 218 may include a plurality of inner optical devices 224 and outer optical devices 226 formed in the light guide 212, wherein each optical device 224, 226 directs light in a desired lighting pattern. The outer optical devices 226 may be disposed adjacent an edge of the light guide 212. The inner optical devices 224 may be disposed between the outer optical devices 226. It is understood that any number and any configuration of inner optical devices 224 and outer optical devices 226 may be included, as desired. Each of the inner optical devices 224 and the outer optical devices 226 may be adapted to receive at least one of the first light source 214 and the second light source 216. It is understood that each of the inner optical devices 224 and the outer optical devices 226 may be adapted to receive additional optical elements such as reflectors and collimating optics, for example. It is understood that the first side 220 and second side 222 of the light guide 212 may also be adapted to receive additional optical elements (not shown) for creating a desired lighting effect.

The first light source 214 is disposed adjacent the light directing device 232. Although the first light source 214 is shown as a plurality of high intensity LEDs, it is understood that the first light source 214 may be any conventional light source, as desired. Other suitable light sources may also be employed.

The second light source 216 is disposed adjacent the light directing device 232. Although the second light source 216 is shown as a low intensity LED, it is understood that the second light source 216 may be any conventional light source, as desired. Other suitable light sources may also be employed.

The light directing device 232 is disposed between the light guide 212 and the light sources 214, 216. The light directing device 232 is adapted to direct a substantial portion of the light emitted from each of the first light source 214 and the second light source 216 into at least one of the light inputs 234. It is understood that the light directing device 232 may include any conventional device for directing light in a desired direction and lighting pattern such as a light pipe, a reflector, a mirror, a lens, and a prism, for example.

The light inputs 234 are disposed adjacent the optical devices 218 of the light guide 212. As a non-limiting example, the light inputs 234 are formed in the inner optical devices 224 and the outer optical devices 226. The light inputs 234 are adapted to receive light emitted from the light directing device 232 and direct the light into the light guide 212. It is understood that the light inputs 234 may include reflectors and other optical elements for receiving and directing light.

In operation, the first light source 214 may emit high intensity light rays 228 into the light directing device 232. The light directing device 232 directs a substantial portion of the high intensity light rays 228 toward at least one of the light inputs 234 of the light guide 212. The light inputs 234 receive a substantial portion of the high intensity light rays 228 emitted from the light directing device 232 and further direct the high intensity light rays 228 into the light guide 212. The high intensity light rays 228 are reflected and substantially collimated by at least one of the optical devices 218. The optical devices 218 direct the high intensity light rays 228 through the light guide 212. The high intensity light rays 228 are emitted through the second side 222 of the light guide 212 to produce a desired lighting effect.

The second light source 216 may emit low intensity light rays 230 into the light directing device 232. The light directing device 232 directs a substantial portion of the low intensity light rays 230 toward at least one of the light inputs of the light guide 212. The light inputs 234 receive a substantial portion of the low intensity light rays 230 emitted from the means for directing light 232 and further direct the low intensity light rays 230 into the light guide 212. The low intensity light rays 230 are reflected and substantially collimated by the at least one of the optical devices 218. The optical devices 218 direct the low intensity light rays 230 through the light guide 212. The low intensity light rays 230 are emitted through the second side 222 of the light guide 212 to produce a desired lighting effect.

As shown, the high intensity light rays 228 emitted by the first light source 214 are directed into a substantially uniform, narrow, high intensity lighting pattern, thereby providing a rear fog light function. The low intensity light rays 230 emitted by the second light source 216 are directed into a substantially uniform, wide, low intensity lighting pattern, thereby providing a position or tail lighting function. It is understood that the light sources 214, 216, the light directing device 232, the optical devices 218, and the light guide 212 may be adapted to produce various lighting patterns, as desired.

The lighting system 10, 110, 210 of the present invention provides a common optical system including both rear fog and rear position or tail functions. The lighting system 10, 110, 210 further provides a compact system that allows for styling flexibility and unique appearance.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A lighting system comprising:
a light guide having a plurality of optical devices formed therein;
a first light source disposed adjacent one of the optical devices, wherein the optical device substantially collimates light rays emitted from the first light source through the light guide and into a first desired lighting pattern; and
a second light source disposed adjacent one of the optical devices, wherein the optical device reflects and substantially collimates light rays emitted from the second light source through the light guide and into a second desired lighting pattern.

2. The lighting system according to claim 1, wherein the optical devices are a plurality of protrusions, the protrusions adapted to receive at least one of the first light source and the second light source.

3. The lighting system according to claim 2, wherein the protrusions have an arcuate shape.

4. The lighting system according to claim 1, wherein the optical devices include a plurality of outer optical devices disposed adjacent an edge of the light guide, the outer optical devices adapted to produce the first desired lighting pattern.

5. The lighting system according to claim 4, wherein the optical devices include a plurality of inner optical devices disposed between the outer optical devices, the inner optical devices adapted to produce the second desired lighting pattern.

6. The lighting system according to claim 1, wherein the first light source is at least one high intensity LED.

7. The lighting system according to claim 1, wherein the second light source is at least one low intensity LED.

8. The lighting system according to claim 1, further comprising a light directing device for directing the light emitted from the first light source into a plurality of first light inputs wherein the first light inputs direct the light emitted from the light directing device into the light guide.

9. The lighting system according to claim 1, further comprising a light directing device for directing the light emitted from the second light source into a plurality of second light inputs, wherein the second light inputs direct the light emitted from the light directing device into the light guide.

10. A lighting system comprising:
a light guide having a plurality of optical devices formed therein;
a first light source disposed adjacent the light guide;
a light directing device for directing the light emitted from the first light source into a plurality of first light inputs, wherein the first light inputs direct the light emitted from the light directing device toward at least one of the optical devices, the optical device substantially collimating the emitted light through the light guide and into a first lighting pattern; and
a second light source disposed adjacent one of the optical devices, wherein the optical device reflects and substantially collimates light rays emitted from the second light source through the light guide and into a second lighting pattern.

11. The lighting system according to claim 10, wherein the optical devices are a plurality of protrusions, the protrusions adapted to receive at least one of the first light source, the second light source, and the first light inputs.

12. The lighting system according to claim 11, wherein the protrusions have an arcuate shape.

13. The lighting system according to claim 10, wherein the first light source is at least one high intensity LED.

14. The lighting system according to claim 10, wherein the second light source is at least one low intensity LED.

15. The lighting system according to claim 10, further comprising a light directing device for directing the light emitted from the second light source into a plurality of second light inputs, wherein the second light inputs direct the light emitted from the light directing device into the light guide.

16. A lighting system comprising:
a light guide having a plurality of optical devices formed therein;
a first light source disposed adjacent the light guide;
a light directing device for directing the light emitted from the first light source into a plurality of first light inputs, wherein the first light inputs direct the light emitted from the light directing device toward at least one of the optical devices, the optical device substantially collimating the emitted light through the light guide and into a first lighting pattern;
a second light source disposed adjacent the light guide; and
a light directing device for directing the light emitted from the second light source into a plurality of second light inputs, wherein the second light inputs direct the light emitted from the light directing device toward at least one of the optical devices, the optical device substantially collimating the emitted light through the light guide and into a second lighting pattern.

17. The lighting system according to claim 16, wherein the optical devices are a plurality of protrusions, the protrusions adapted to receive at least one of the first light source, the second light source, the first light inputs, and the second light inputs.

18. The lighting system according to claim 17, wherein the protrusions have an arcuate shape.

19. The lighting system according to claim 16, wherein the first light source is at least one high intensity LED.

20. The lighting system according to claim 16, wherein the second light source is at least one low intensity LED.
